(19) United States
(12) Patent Application Publication
(10) Pub. No.: US 2009/0206241 A1
(43) Pub. Date: Aug. 20, 2009

(54) IMAGE SENSOR

(75) Inventors: Jin Hak Kim, Seoul (KR); Eugene Fainstain, Ramat-Gab (IS); Hiromichi Tanaka, Gyeonggi-do (KR); Yong In Han, Gyeonggi-do (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 12/369,345

(22) Filed: Feb. 11, 2009

(30) Foreign Application Priority Data
Feb. 11, 2008 (KR) 10-2008-0012126

(51) Int. Cl. G01J 3/51

(52) U.S. Cl. 250/226

(57) ABSTRACT

An image sensor that includes a plurality of light detection units and a filter array including a plurality of filters, wherein each filter is disposed on a corresponding one of the light detection units. The filter array includes a first white filter that transmits light incident light on the filter array, a yellow filter that transmits a yellow component of the incident light, and a cyan filter that transmits a cyan component of the incident light.

### CROSS-REFERENCE TO RELATED APPLICATION

This application claims priority under 35 U.S.C. § 119 to Korean Patent Application No. 10-2008-0012126, filed on Feb. 11, 2008, in the Korean Intellectual Property Office, the disclosure of which is incorporated by reference herein in its entirety.

### BACKGROUND

1. Technical Field

The present invention relates to an image sensor, and more particularly, to an image sensor capable of canceling crosstalk without reducing a signal to noise ratio (SNR) of a luminance signal.

2. Discussion of the Related Art

A complementary metal oxide semiconductor (CMOS) image sensor (CIS) having characteristics such as low power consumption, compact size, and low cost may be used in place of a charge coupled device (CCD). An image sensor uses an array of pixels to capture an image.

However, as the size of a pixel decreases, the area of its photodiode decreases. Accordingly, even if an on-chip microlens is used, since the amount of light incident on the pixel decreases, the number of electrons generated by the photodiode decreases so that an image sensor's sensitivity may be reduced.

To increase the sensitivity of an image sensor, the distance between adjacent pixels can be decreased. However, this may cause crosstalk between the adjacent pixels to increase. Thus, a signal to noise ratio (SNR) of a luminance signal may be decreased, which can cause an image sensor's color reproduction to deteriorate.

In a conventional red, green, blue (RGB) Bayer pattern, transmissivity is low because each of its color filters absorbs incident light. Because the sensitivity of a luminance signal is not high due to the low transmissivity of the RGB Bayer pattern's color filters, crosstalk may not be easily removed.

Accordingly, there exists a need for an image sensor with improved sensitivity.

### SUMMARY

According to an exemplary embodiment of the present invention, there is provided an image sensor including a plurality of light detection units and a filter array including a plurality of filters, wherein each filter is disposed on a corresponding one of the light detection units. The filter array includes a first white filter that transmits light incident on the filter array, a yellow filter that transmits a yellow component of the incident light, and a cyan filter that transmits a cyan component of the incident light.

The first white filter and the yellow filter are located in a same row of the filter array. The first white filter and the cyan filter are located in a same row of the filter array. The filter array includes a rectangular pattern. The filter array further includes a second white filter that transmits the incident light, and the first and second white filters are alternately arranged in consecutive rows of the filter array.

The light detection units include a first light detection unit that converts light passing through the first white filter to a first electrical signal, a second light detection unit that converts light passing through the second white filter to a second electrical signal, a third light detection unit that converts light passing through the yellow filter to a third electrical signal, and a fourth light detection unit that converts light passing through the cyan filter to a fourth electrical signal.

The image sensor further includes a first operation circuit that calculates a red signal by subtracting the fourth electrical signal from the first electrical signal, and a second operation circuit that calculates a blue signal by subtracting the third electrical signal from the second electrical signal. The image sensor further includes a third operation circuit that calculates a green signal based on the first electrical signal, the second electrical signal, the red signal, and the blue signal. The image sensor further includes a third operation circuit that calculates a green signal based on the first through fourth electrical signals.

The second white filter and the yellow filter are located in a same row of the filter array. The second white filter and the cyan filter are located in a same row of the filter array. The light detection units further include another one of each of the first through fourth light detection units.

The first light detection unit has one of the third light detection units on its left side and the other third light detection unit on its right side, and one of the second light detection units on its upper side and the other second light detection unit on its lower side. The second light detection unit has one of the fourth light detection units on its left side and the other fourth light detection unit on its right side, and one of the first light detection units on its upper side and the other first light detection unit on its lower side.

The third light detection unit has one of the first light detection units on its left side and the other first light detection unit on its right side, and one of the fourth light detection units on its upper side and the other fourth light detection unit on its lower side. The fourth light detection unit has one of the second light detection units on its left side and the other second light detection unit on its right side, and one of the third light detection units on its upper side and the other third light detection unit on its lower side.

The plurality of light detection units include photodiodes.

According to an exemplary embodiment of the present invention, there is provided an image sensor including a light detecting array including a plurality of light detection units formed on a semiconductor substrate, and a filter array including a plurality of filters, wherein each filter is disposed on a corresponding one of the light detection units, wherein the filter array includes a yellow filter that transmits a yellow spectrum range of light incident on the filter array, and a cyan filter that transmits a cyan spectrum range of the incident light.

The light detecting array includes a first light detection unit that converts light incident on the first light detection unit to a first electrical signal, a second light detection unit that converts light incident on the second light detection unit to a second electrical signal, a third light detection unit that converts light passing through the yellow filter to a third electrical signal, a fourth light detection unit that converts light passing through the cyan filter to a fourth electrical signal. The image sensor further includes a first operation circuit that calculates a blue signal by subtracting the third electrical signal from the second electrical signal, and a second operation circuit that calculates a red signal by subtracting the fourth electrical signal from the first electrical signal, to thereby reduce crosstalk.

### BRIEF DESCRIPTION OF THE DRAWINGS

The above and other features of the present invention will become more apparent by describing in detail exemplary embodiments thereof with reference to the accompanying drawings in which:

FIGS. 1A and 1B, respectively, illustrate a conventional Bayer pattern and an average sensitivity of its light detection units;

FIGS. 2A and 2B, respectively, illustrate a color filter array according to an exemplary embodiment of the present invention and a sensitivity of pixels of the color filter array;

FIG. 3 is a graph showing light transmissivity of a white filter, a yellow filter, and a cyan filter of a color filter array according to an exemplary embodiment of the present invention;

FIGS. 4A and 4B, respectively, are a block diagram illustrating a yellow pixel according to an exemplary embodiment of the present invention and a graph for explaining crosstalk affecting the yellow pixel;

FIGS. 5A and 5B, respectively, are a block diagram illustrating a cyan pixel according to an exemplary embodiment of the present invention and a graph for explaining crosstalk affecting the cyan pixel;

FIGS. 6A and 6B, respectively, are a block diagram illustrating a first white pixel according to an exemplary embodiment of the present invention and a graph for explaining crosstalk affecting the first white pixel;

FIGS. 7A and 7B, respectively, are a block diagram illustrating a second white pixel according to an exemplary embodiment of the present invention and a graph for explaining crosstalk affecting the second white pixel;

FIG. 8 is a block diagram illustrating an image sensor according to an exemplary embodiment of the present invention;

FIG. 9 is a graph for explaining the operation of a red signal operation unit of the image sensor of FIG. 8 according to an exemplary embodiment of the present invention;

FIG. 10 is a graph for explaining the operation of a blue signal operation unit of the image sensor of FIG. 8 according to an exemplary embodiment of the present invention; and

FIG. 11 is a graph for explaining the operation of a green signal operation unit of the image sensor of FIG. 8 according to an exemplary embodiment of the present invention.

### DETAILED DESCRIPTION OF EXEMPLARY EMBODIMENTS

Hereinafter, exemplary embodiments of the present invention will be described more fully with reference to the accompanying drawings. This invention may, however, be embodied in many different forms and should not be construed as limited to the embodiments set forth herein.

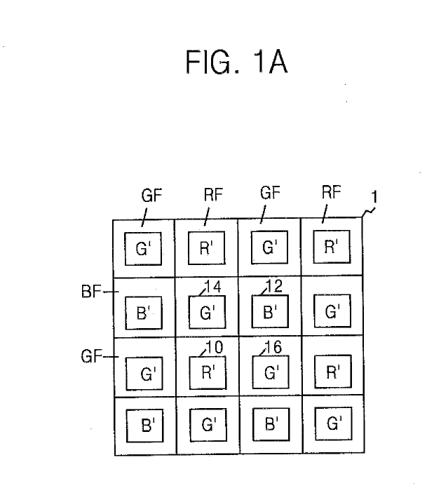

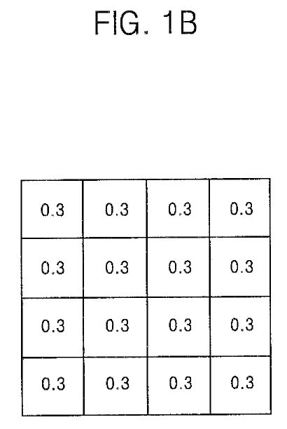

FIGS. 1A and 1B, respectively, illustrate a conventional Bayer pattern 1 and an average sensitivity of its light detection units. FIG. 1A illustrates the conventional Bayer pattern 1 in which RF, GF, and BF, respectively, denote a red filter, a green filter, and a blue filter. In addition, R′ denotes a red detection unit capable of detecting light passing through the RF, G′ denotes a green detection unit capable of detecting light passing through the GF, and B′ denotes a blue detection unit capable of detecting light passing through the BF.

Referring to FIG. 1B, an average sensitivity of the light detection units R′, G′, and B′ is 0.3. For example, a red detection unit 10 is affected by crosstalk generated by the light passing through each of four GFs located at the upper, lower, left, and right sides of the red detection unit 10 and a blue detection unit 12 is affected by crosstalk generated by the light passing through each of four GFs located at the upper, lower, left, and right sides of the blue detection unit 12.

In addition, a green detection unit 14 is affected by crosstalk generated by the light passing through each of two RFs located at the upper and lower sides of the green detection unit 14 and crosstalk generated by the light passing through each of two BFs located at the left and right sides of the green detection unit 14. Another green detection unit 16 is affected by crosstalk generated by the light passing through each of two BFs located at the upper and lower sides of the green detection unit 16 and crosstalk generated by the light passing through each of two RFs located at the left and right sides of the green detection unit 16. Thus, crosstalk is not canceled in an interpolation process that is performed in an image sensor including the Bayer pattern 1.

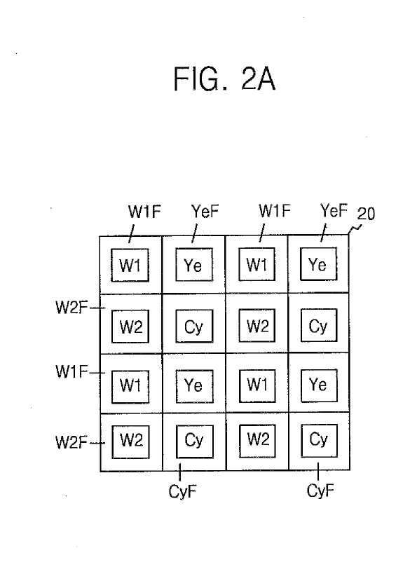

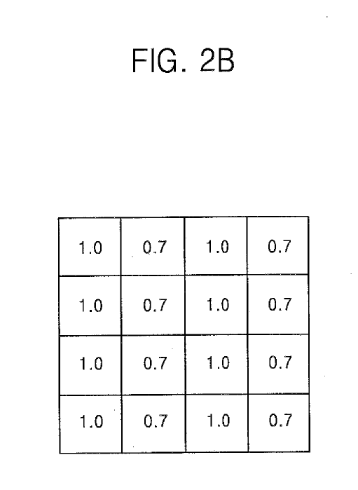

FIGS. 2A and 2B, respectively, illustrate a color filter array 20 according to an exemplary embodiment of the present invention and a sensitivity of pixels of the color filter array. Referring to FIGS. 2A and 2B, the color filter array 20 includes a plurality of W1Fs, a plurality of W2Fs, a plurality of YeFs, and a plurality of CyFs. The color filter array 20 has a plurality of 2×2 patterns. Each of the 2×2 patterns includes W1F, YeF, CyF, and W2F, as shown in FIG. 2A. W1F, YeF, CyF, and W2F, respectively, denote a first white filter, a yellow filter, a cyan filter, and a second white filter.

Luminance transmission characteristics of W1F and W2F may be the same as or different from each other according to exemplary embodiments of the present invention. W1F and W2F are alternatively arranged in rows. While Yef is arranged between neighboring W1Fs, CyF is arranged between neighboring W2Fs. However, YeF may be arranged between two W2Fs and CyF may be arranged between two W1Fs, according to exemplary embodiments of the present invention.

In addition, W1 denotes a first light detection unit or a first white pixel detecting the light passing through W1F. Ye denotes a second light detection unit or a yellow pixel detecting the light passing through YeF. Cy denotes a third light detection unit or a cyan pixel detecting the light passing through CyF. W2 denotes a fourth light detection unit or a second white pixel detecting the light passing through W2F. Each of the first through fourth light detection units W1, Ye, Cy, and W2 may convert an optical signal to an electrical signal. For example, each of the first through fourth light detection units W1, Ye, Cy, and W2 may be embodied by a photodiode formed on a semiconductor substrate.

As shown in FIG. 2B, the sensitivity of each of the first and second white pixels W1 and W2 is 1.0 and the sensitivity of each of the yellow pixel Ye and the cyan pixel Cy is 0.7. Each of YeF and CyF is a complementary filter. For example, light transmissivity of a complementary filter like YeF and CyF is higher than that of each of primary color filters RF, GF, and BF shown in FIG. 1A.

When the color filter array 20 as shown in FIG. 2A is used, the average sensitivity of the light detection units formed under the color filter array 20 is 0.83, which is higher than that of 0.3 for the light detection units formed under the Bayer pattern 1 of FIG. 1A. Since the light passing through each of W1F, Ye, CyF, and W2F transmits a large quantity of a green component, for example, a luminance component of incident light, W1F, YeF, CyF, and W2F may improve the sensitivity of each of the color filter array's 20 light detection units.

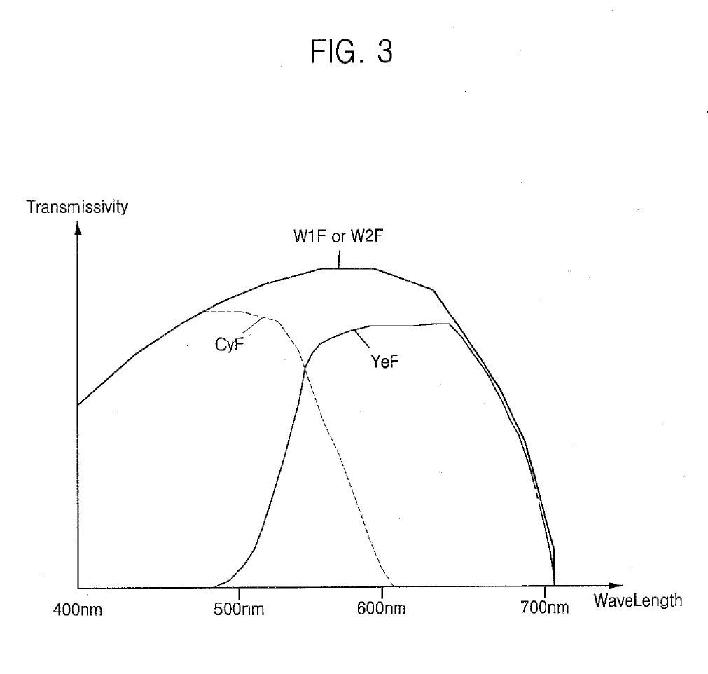

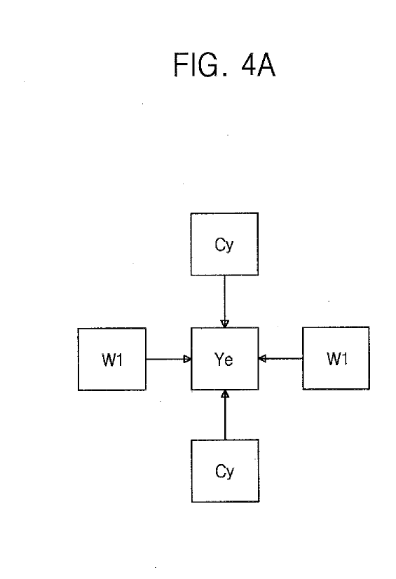

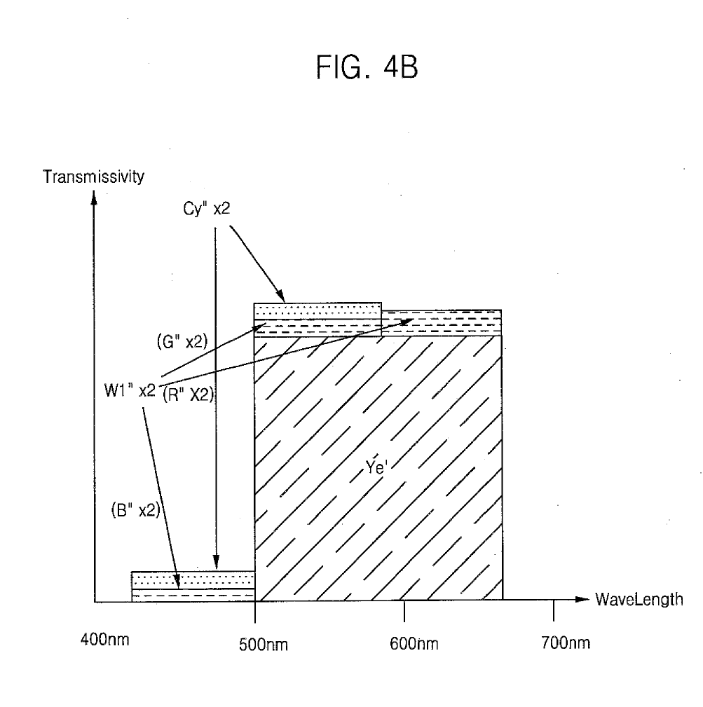

FIG. 3 is a graph showing light transmissivity (or relative light transmissivity) of a white filter, a yellow filter, and a cyan filter of a color filter array according to an exemplary embodiment of the present invention. FIGS. 4A and 4B, respectively, are a block diagram illustrating a yellow pixel according to an exemplary embodiment of the present invention and a graph for explaining crosstalk affecting the yellow pixel. Referring to FIGS. 2A and 4A, the cyan pixels Cy are arranged at the upper and lower sides of the yellow pixel Ye and the first white pixels W1 are arranged at the left and right sides of the yellow pixel Ye.

As shown in FIGS. 4A and 4B, the yellow pixel Ye is affected by crosstalk due to the light passing through each of the four filters W1F and CyF. In FIG. 4B, “×2” signifies two times. For example, the yellow pixel Ye is affected not only by light Ye′ having a yellow component and passing through YeF, in other words, light synthesized of light having a red component and light having a green component, but also by crosstalk W1″ due to light having a white component and passing through each of the two W1Fs, where the crosstalk W1″ includes crosstalk R″ due to light having a red component, crosstalk G″ due to light having a green component, and crosstalk B″ due to light having a blue component. Simultaneously, the yellow pixel Ye is affected by crosstalk Cy″ due to light having a cyan component and passing through each of the two CyFs, where the crosstalk Cy″ includes the crosstalk B″ due to light having a blue component and the crosstalk G″ due to light having a green component. In other words, the yellow pixel Ye is affected by a total crosstalk of 2×(R″+2G″+2B″) due to the light passing through each of the filters W1F and CyF arranged at the four sides of the yellow pixel Ye.

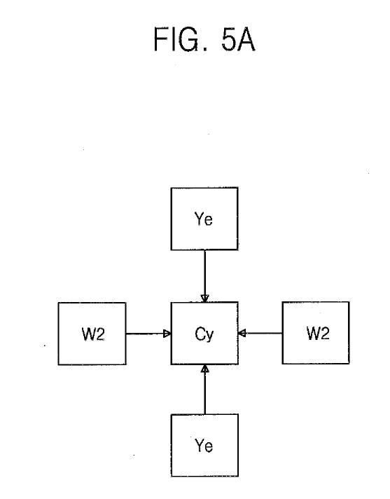

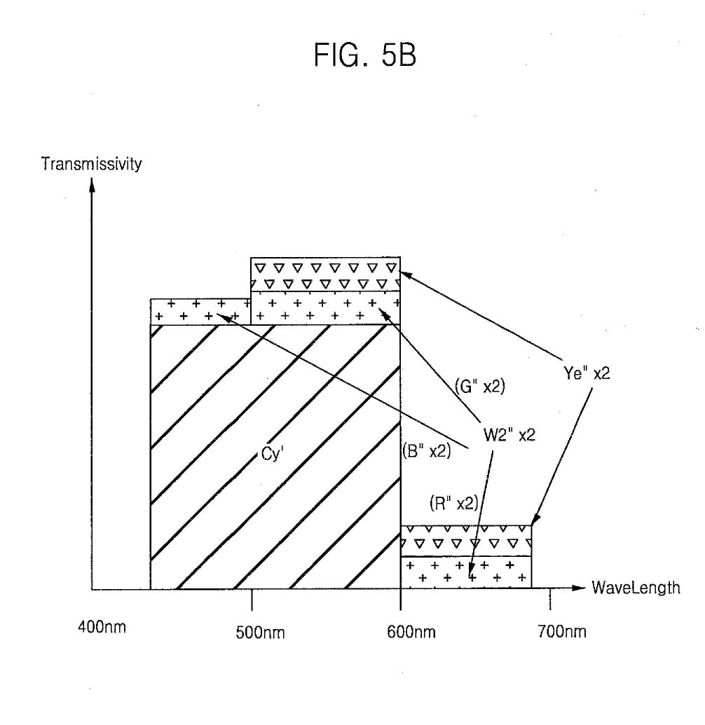

FIGS. 5A and 5B, respectively, are a block diagram illustrating a cyan pixel according to an exemplary embodiment of the present invention and a graph for explaining crosstalk affecting the cyan pixel. Referring to FIGS. 2A and 5A, the yellow pixels Ye are arranged at the upper and lower sides of the cyan pixel Cy and the second white pixels W2 are arranged at the left and right sides of the cyan pixel Cy.

As shown in FIGS. 5A and 5B, the cyan pixel Cy is affected by crosstalk due to the light passing through each of the four filters W2F and YeF. In FIG. 5B, “×2” signifies two times. For example, the cyan pixel Cy is affected not only by light Cy′ having a cyan component and passing through CyF, in other words, light synthesized of light having a green component and light having a blue component, but also by crosstalk W2″ due to light having a white component and passing through each of the two W2Fs, where the crosstalk W2″ includes, crosstalk R″ due to light having a red component, crosstalk G″ due to light having a green component, and crosstalk B″ due to light having a blue component. Simultaneously, the cyan pixel Cy is affected by crosstalk Ye″ due to light having a yellow component and passing through each of the two YeFs, where the crosstalk Ye″ includes the crosstalk R″ due to light having a red component and the crosstalk G″ due to light having a green component. In other words, the cyan pixel Cy is affected by a total crosstalk of 2×(2R″+2G″+B″) due to the light passing through each of the filters W2F and YeF arranged at the four sides of the cyan pixel Cy.

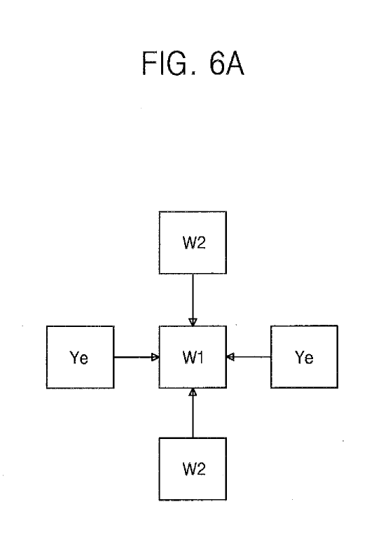

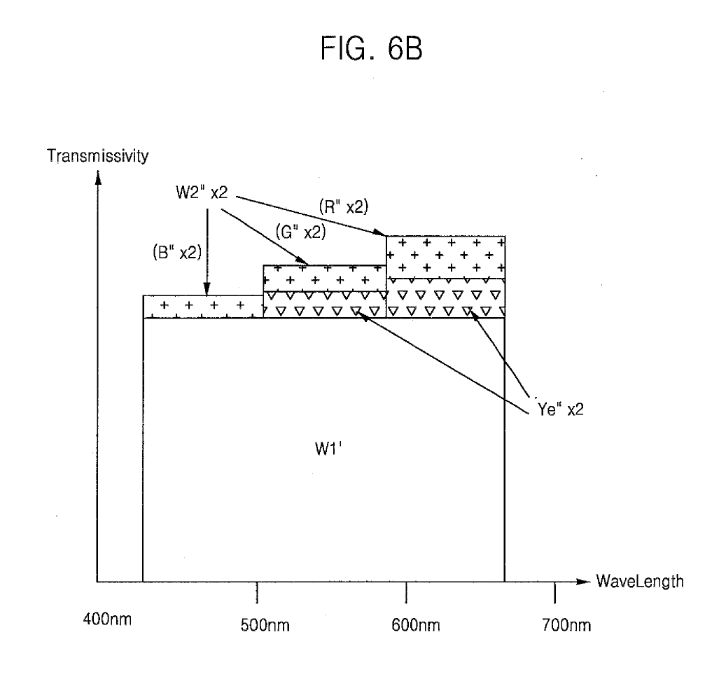

FIGS. 6A and 6B, respectively, are a block diagram illustrating a first white pixel according to an exemplary embodiment of the present invention and a graph for explaining crosstalk affecting the first white pixel. Referring to FIGS. 2A and 6A, the second white pixels W2 are arranged at the upper and lower sides of the first white pixel W1 and the yellow pixels Ye are arranged at the left and right sides of the first white pixel W1.

As shown in FIGS. 6A and 6B, the first white pixel W1 is affected by crosstalk due to the light passing through each of the four filters W2F and YeF. In FIG. 6B, “×2” signifies two times. For example, the first white pixel W1 is affected not only by light W1′ having a white component and passing through W1F, in other words, light synthesized of light having a red component, light having a green component and light having a blue component, but also by crosstalk W2″ due to light having a white component and passing through each of the two W2Fs, where the crosstalk W2″ includes crosstalk R″ due to light having a red component, crosstalk G″ due to light having a green component, and crosstalk B″ due to light having a blue component. Simultaneously, the first white pixel W1 is affected by crosstalk Ye″ due to light having a yellow component and passing through each of the two YeFs, where the crosstalk Ye″ includes the crosstalk R″ due to light having a red component and the crosstalk G″ due to light having a green component. In other words, the first white pixel W1 is affected by a total crosstalk of 2×(2R″+2G″+B″) due to the light passing through each of the filters W2F and YeF arranged at the four sides of the first white pixel W1.

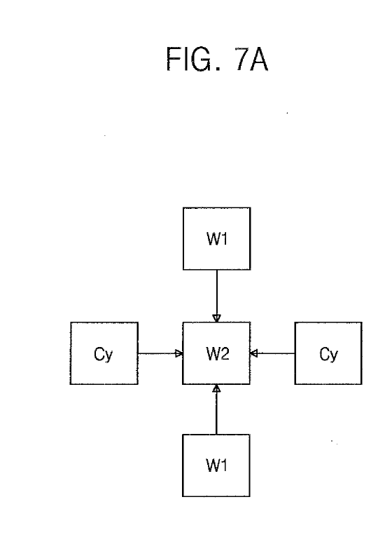

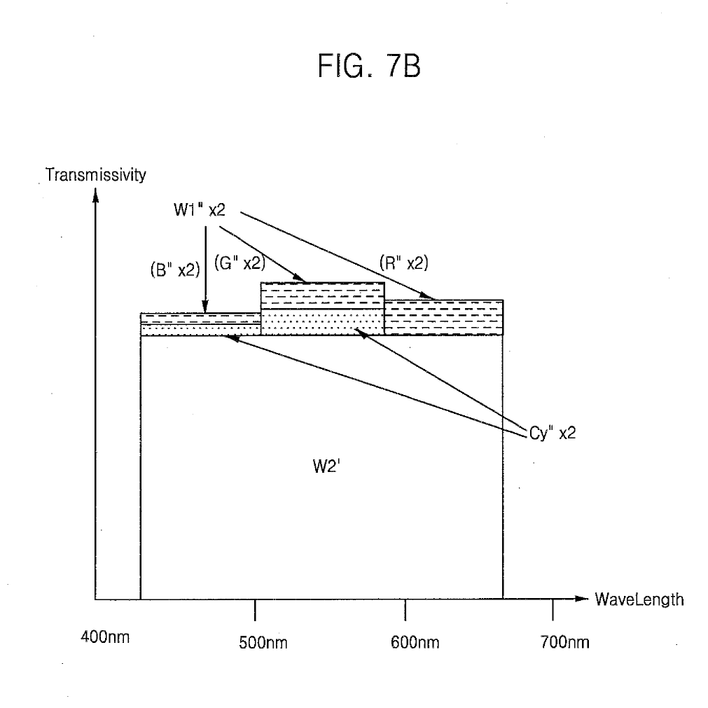

FIGS. 7A and 7B, respectively, are a block diagram illustrating a second white pixel according to an exemplary embodiment of the present invention and a graph for explaining crosstalk affecting the second white pixel. Referring to FIGS. 2A and 7A, the first white pixels W1 are arranged at the upper and lower sides of the second white pixel W2 and the cyan pixels Cy are arranged at the left and right sides of the second white pixel W2.

As shown in FIGS. 7A and 7B, the second white pixel W2 is affected by crosstalk due to the light passing through each of the four filters W1F and CyF. In FIG. 7B, “×2” signifies two times. For example, the second white pixel W2 is affected not only by light W2′ having a white component and passing through W2F, in other words, light synthesized of light having a red component, light having a green component, and light having a blue component, but also by crosstalk W1″ due to light having a white component and passing through each of the two W1Fs, where the crosstalk W1″ includes crosstalk R″ due to light having a red component, crosstalk G″ due to light having a green component, and crosstalk B″ due to light having a blue component. Simultaneously, the second white pixel W2 is affected by crosstalk Cy″ due to light having a cyan component and passing through each of the two CyFs, where the crosstalk Cy″ includes the crosstalk G″ due to light having a green component and the crosstalk B″ due to light having a blue component. In other words, the second white pixel W2 is affected by a total crosstalk of 2×(R″+2G″+2B″) due to the light passing through each of the filters W1F and CyF arranged at the four sides of the second white pixel W2.

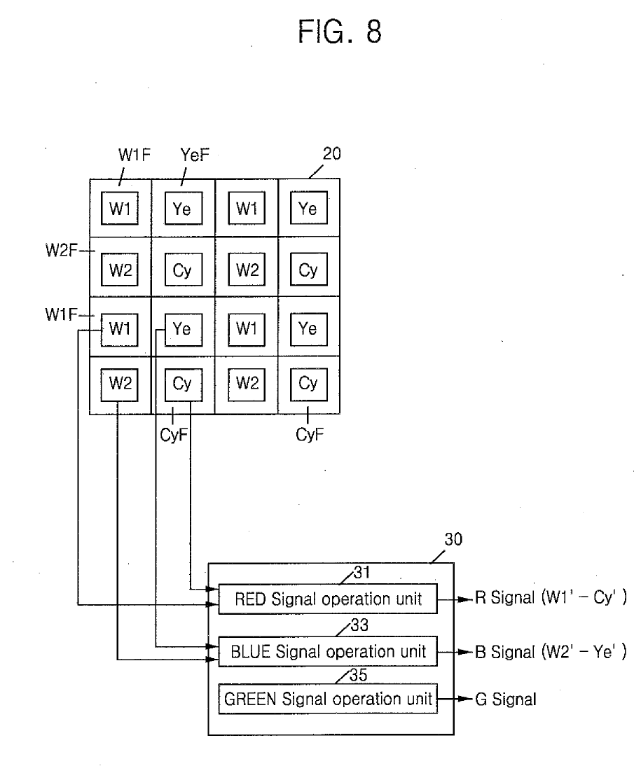

FIG. 8 is a block diagram illustrating an image sensor according to an exemplary embodiment of the present invention. Referring to FIG. 8, the image sensor, which is used as an image pick-up device, includes the color filter array 20, a plurality of light detection units W1, Ye, Cy, and W2, and an operation (calculation) unit 30. The color filter array 20 may have a structure and function similar to that described-above with reference to FIGS. 2A and 2B. For example, the color filter array 20 includes a plurality of filters W1F, YeF, CyF, and W2F, which are used to transit a particular color component or spectrum range of an incident light. Each of the light detection units W1, Ye, Cy, and W2 detects light passing through a corresponding one of the filters W1F, YeF, CyF, and W2F and generates an electrical signal as a result of the detection.

The operation unit 30 includes a red signal operation (calculation) unit 31, a blue signal operation unit 33, and a green signal operation unit 35. The red signal operation unit 31 subtracts an electrical signal output from the cyan pixel Cy from an electrical signal output from the first white pixel W1 to generate a red signal where crosstalk is canceled. The blue signal operation unit 33 subtracts an electrical signal output from the yellow pixel Ye from an electrical signal output from the second white pixel W2 to generate a red signal where crosstalk is canceled. The green signal operation unit 35 may calculate a green signal according to Equation 1 or Equation 2.

$$\begin{matrix}\begin{matrix}( W {1}^{′} + W {2}^{′} ) / 2 - ( R + B ) = ( ( \begin{matrix}R + G + B + 2 {R}^{″} + \\ 2 {G}^{″} + {B}^{″}\end{matrix} ) + \\ ( R + G + B + {R}^{″} + 2 {G}^{″} + 2 {B}^{″} ) ) / \\ 2 - ( R + B ) \\ = G + ( 3 {R}^{″} + 4 {G}^{″} + 3 {B}^{″} ) / 2 \\ = G + 2 {G}^{″} + ( 1.5 {R}^{″} + 1.5 {B}^{″} )\end{matrix} \\ \begin{matrix}G + 2 {G}^{″} = ( W {1}^{′} + W {2}^{′} ) / 2 - ( R + B ) - \\ ( 1.5 {R}^{″} + 1.5 {B}^{″} ) \\ = ( W {1}^{′} + W {2}^{′} ) / 2 - ( ( R - 1.5 {R}^{″} ) + \\ ( B - 1.5 {B}^{″} ) )\end{matrix} & ( Equation 1 ) \\ \begin{matrix}( {Ye}^{′} + {Cy}^{′} ) - ( W {1}^{′} + W {2}^{′} ) / 2 = ( ( R + G + {R}^{″} + 2 {G}^{″} + 2 {B}^{″} ) + \\ ( G + B + 2 {R}^{″} + 2 {G}^{″} + {B}^{″} ) ) - \\ ( ( R + G + B + 2 {R}^{″} + 2 {G}^{″} + {B}^{″} ) + \\ ( R + G + B + {R}^{″} + 2 {G}^{″} + 2 {B}^{″} ) ) / 2 \\ = G + 1.5 {R}^{″} + 2 {G}^{″} + 1.5 {B}^{″}\end{matrix} \\ G + 2 {G}^{″} = ( {Ye}^{′} + {Cy}^{′} ) - ( W {1}^{′} + W {2}^{′} ) / 2 - ( 1.5 {R}^{″} + 1.5 {B}^{″} ) & ( Equation 2 )\end{matrix}$$

In Equations 1 and 2, “R” denotes light having a red component or a red spectrum range, “G” denotes light having a green component or a green spectrum range, and “B” denotes light having a blue component or a blue spectrum range.

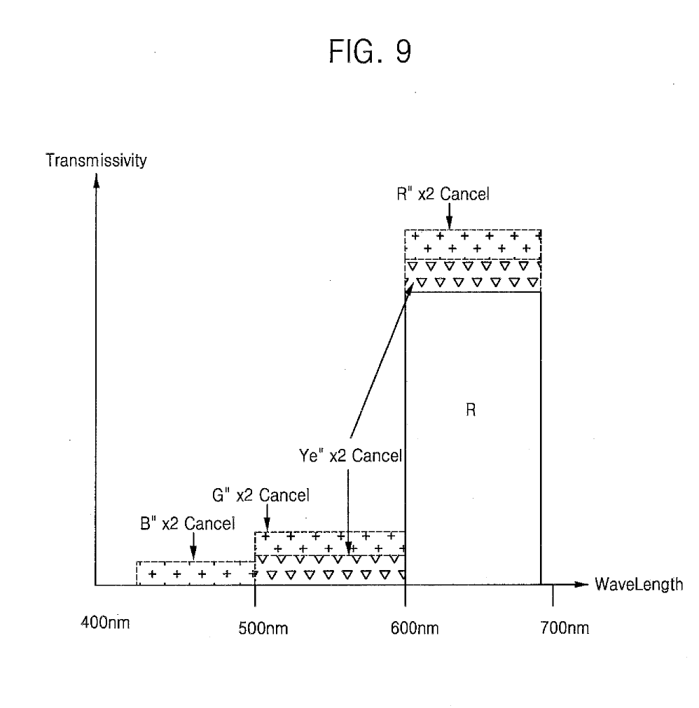

FIG. 9 is a graph for explaining the operation of the red signal operation unit 31 of FIG. 8 according to an exemplary embodiment of the present invention. For convenience of explanation, in FIG. 9, a process of canceling crosstalk is illustrated by showing how much transmissivity remains at a particular wavelength. For example, as shown in FIG. 9, only light having a red component where crosstalk is canceled remains. This is accomplished by subtracting, at the red spectrum range, the transmissivity graph of FIG. 5B from the transmissivity graph of FIG. 6B. In addition, the red signal operation unit 31 subtracts an electrical signal output from the cyan pixel Cy from an electrical signal output from the first white pixel W1 so that a red signal can be output where crosstalk is completely canceled.

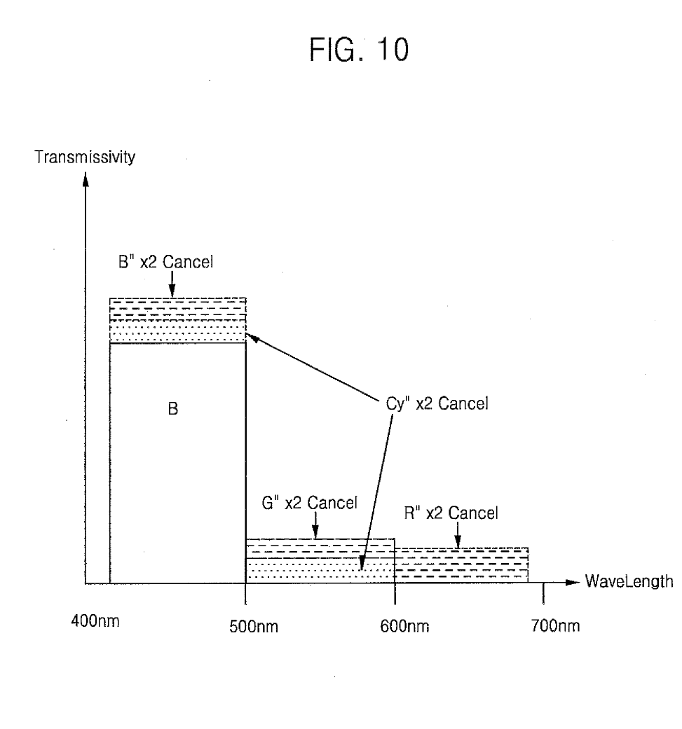

FIG. 10 is a graph for explaining the operation of the blue signal operation unit 33 of FIG. 8 according to an exemplary embodiment of the present invention. For convenience of explanation, in FIG. 10, a process of canceling crosstalk is illustrated by showing how much transmissivity remains at a particular wavelength. For example, as shown in FIG. 10, only light having a blue component where crosstalk is canceled remains. This is accomplished by subtracting, at the blue spectrum range, the transmissivity graph of FIG. 4B from the transmissivity graph of FIG. 7B. In addition, the blue signal operation unit 33 subtracts an electrical signal output from the yellow pixel Ye from an electrical signal output from the second white pixel W2 so that a blue signal can be output where crosstalk is completely canceled.

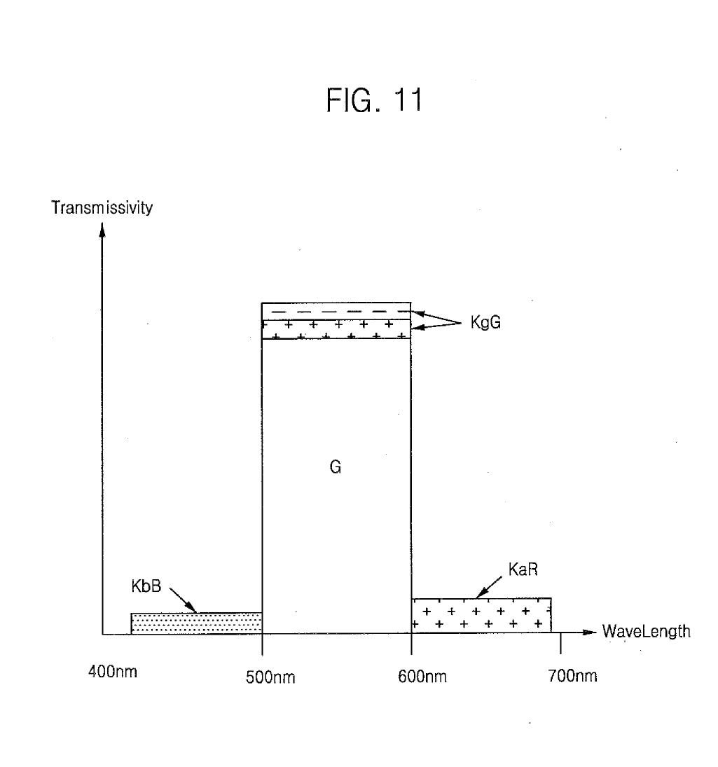

FIG. 11 is a graph for explaining the operation of the green signal operation unit 35 of FIG. 8 according to an exemplary embodiment of the present invention. Referring to FIGS. 6B, 7B, 9, 10, and 11 and Equation 1, the green signal operation unit 35 outputs a green signal based on the electrical signal output from the first white pixel W1, the electrical signal output from the second white pixel W2, the red signal output from the red signal operation unit 31, and the blue signal output from the blue signal operation unit 33. In this case, in the green signal, not all crosstalk is canceled so that part of the crosstalk remains.

Referring to FIGS. 4B, 5B, 6B, 7B, and 11 and Equation 2, the green signal operation unit 35 outputs a green signal based on the electrical signal output from the first white pixel W1, the electrical signal output from the second white pixel W2, the electrical signal output from the yellow pixel Ye, and the electrical signal output from the cyan pixel Cy. In this case, in the green signal, not all crosstalk is canceled so that part of the crosstalk remains. Each of “Ka”, “Kb”, and “Kg” of FIG. 11 denotes a coefficient.

The image sensor including the color filter array 20 that includes the white filter, the yellow filter, and the cyan filter according to the present exemplary embodiment may have an improved sensitivity because it can increase light transmissivity. In addition, the color filter array 20 according to the present exemplary embodiment may not include the first white filter W1F and the second white filter W2F. In this case, light may be incident on each of the light detection units W1 and W2.

As described above, an image sensor according to an exemplary embodiment of the present invention may increase transmissivity of an incident light by using the complementary filter and the white filter, improve a signal to noise ratio (SNR) of the luminance signal and cancel crosstalk, thereby improving a sensitivity of the image sensor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image sensor, comprising:
a plurality of light detection units; and
a filter array including a plurality of filters, wherein each filter is disposed on a corresponding one of the light detection units,
wherein the filter array comprises:
a first white filter that transmits light incident on the filter array;
a yellow filter that transmits a yellow component of the incident light; and
a cyan filter that transmits a cyan component of the incident light.

2. The image sensor of claim 1, wherein the first white filter and the yellow filter are located in a same row of the filter array.

3. The image sensor of claim 1, wherein the first white filter and the cyan filter are located in a same row of the filter array.

4. The image sensor of claim 1, wherein the filter array comprises a rectangular pattern.

5. The image sensor of claim 1, wherein the filter array filter comprises a second white filter that transmits the incident light, and wherein the first and second white filters are alternately arranged in consecutive rows of the filter array.

6. The image sensor of claim 5, wherein the light detection units comprise:
a first light detection unit that converts light passing through the first white filter to a first electrical signal;
a second light detection unit that converts light passing through the second white filter to a second electrical signal;
a third light detection unit that converts light passing through the yellow filter to a third electrical signal; and
a fourth light detection unit that converts light passing through the cyan filter to a fourth electrical signal, and
the image sensor further comprises:
a first operation circuit that calculates a red signal by subtracting the fourth electrical signal from the first electrical signal; and
a second operation circuit that calculates a blue signal by subtracting the third electrical signal from the second electrical signal.

7. The image sensor of claim 6, further comprising a third operation circuit that calculates a green signal based on the first electrical signal, the second electrical signal, the red signal, and the blue signal.

8. The image sensor of claim 6, further comprising a third operation circuit that calculates a green signal based on the first through fourth electrical signals.

9. The image sensor of claim 5, wherein the second white filter and the yellow filter are located in a same row of the filter array.

10. The image sensor of claim 5, wherein the second white filter and the cyan filter are located in a same row of the filter array.

11. The image sensor of claim 6, wherein the light detection units further comprise another one of each of the first through fourth light detection units.

12. The image sensor of claim 11, wherein the first light detection unit has one of the third light detection units on its left side and the other third light detection unit on its right side, and one of the second light detection units on its upper side and the other second light detection unit on its lower side.

13. The image sensor of claim 11, wherein the second light detection unit has one of the fourth light detection units on its left side and the other fourth light detection unit on its right side, and one of the first light detection units on its upper side and the other first light detection unit on its lower side.

14. The image sensor of claim 11, wherein the third light detection unit has one of the first light detection units on its left side and the other first light detection unit on its right side, and one of the fourth light detection units on its upper side and the other fourth light detection unit on its lower side.

15. The image sensor of claim 11, wherein the fourth light detection unit has one of the second light detection units on its left side and the other second light detection unit on its right side, and one of the third light detection units on its upper side and the other third light detection unit on its lower side.

16. The image sensor of claim 1, wherein the plurality of light detection units comprise photodiodes.

17. An image sensor, comprising:
a light detecting array including a plurality of light detection units formed on a semiconductor substrate; and
a filter array including a plurality of filters, wherein each filter is disposed on a corresponding one of the light detection units,
wherein the filter array comprises:
a yellow filter that transmits a yellow spectrum range of light incident on the filter array; and
a cyan filter that transmits a cyan spectrum range of the incident light, and
the light detecting array comprises:
a first light detection unit that converts light incident on the first light detection unit to a first electrical signal;
a second light detection unit that converts light incident on the second light detection unit to a second electrical signal;
a third light detection unit that converts light passing through the yellow filter to a third electrical signal; and
a fourth light detection unit that converts light passing through the cyan filter to a fourth electrical signal; and
the image sensor further comprises:
a first operation circuit that calculates a blue signal by subtracting the third electrical signal from the second electrical signal; and
a second operation circuit that calculates a red signal by subtracting the fourth electrical signal from the first electrical signal.

18. The image sensor of claim 17, wherein the plurality of light detection units comprise photodiodes.
